(19) United States
(12) Patent Application Publication
(10) Pub. No.: US 2018/0101874 A1
(43) Pub. Date: Apr. 12, 2018

(54) SYSTEMS AND METHODS FOR PROVIDING CONTEXT-SPECIFIC DIGITAL CONTENT

(71) Applicant: Akisystems LLC, Los Gatos, CA (US)

(72) Inventor: Ziemowit Laski, San Jose, CA (US)

(73) Assignee: Akisystems LLC, Los Gatos, CA (US)

(21) Appl. No.: 15/671,085

(22) Filed: Aug. 7, 2017

Related U.S. Application Data
(60) Provisional application No. 62/407,991, filed on Oct. 13, 2016.
(60) Provisional application No. 62/405,685, filed on Oct. 7, 2016.

(51) Int. Cl. G06Q 30/02

(52) U.S. Cl. CPC G06Q 30/0271; G06Q 30/0253; G06F 17/30525; G06Q 30/0255; G06Q 30/0254

(57) ABSTRACT

A system receives a data chunk including account transaction metadata. The account transaction metadata is anonymized. Supplemental metadata is obtained based on the anonymized account transaction metadata, and the data chunk is annotated using the supplemental metadata. The annotated data chunk is filtered, the filtering removing information capable of identifying an account associated with the account transaction metadata. The filtered annotated data chunk is provided for analysis by a remote third-party system. A set of digital content items provided by the remote third-party system is received, the set of digital content items provided based on analysis of the filtered annotated data chunk. Context-specific digital content is assembled based on the received digital content and is provided for presentation by a remote client device. An operator of the remote client device may select digital content that is deemed relevant. The selection may be reported back to the originating system.

### CROSS-REFERENCE TO RELATED APPLICATIONS

The present application claims the benefit of U.S. Provisional Patent Application Ser. No. 62/405,685, filed Oct. 7, 2016 and entitled “Method and Technical Architecture for Presenting Contextual Advertising for Financial Transactions,” and U.S. Provisional Patent Application Ser. No. 62/407,991, filed Oct. 13, 2016 and entitled “Method and Technical Architecture for Enabling End User Detection of Fraud in Financial Transactions,” which are both hereby incorporated by reference herein.

### TECHNICAL FIELD

This disclosure pertains to systems for providing context-specific digital content. More specifically, this disclosure pertains to anonymizing metadata and providing context-specific digital content based on the anonymized metadata.

### BACKGROUND

Under conventional approaches, digital content may be provided based on public information. For example, digital content may be provided based on public Internet activity (e.g., visited websites or Internet searches). However, these conventional approaches provide limited benefit to users.

### SUMMARY

A claimed solution rooted in computer technology overcomes problems specifically arising in the realm of computer technology. In various embodiments, a computing system is configured to provide context-specific digital content using anonymized metadata (e.g., account transaction metadata, personal metadata). For example, the computing system may receive account transaction metadata (e.g., transaction identifier, billing descriptor, account number) for one or more account transactions (e.g., a retail purchase at a particular retailer). Account transaction metadata may be received in real-time (e.g., at substantially the same time as the account transaction occurs) and/or in batches. The account transaction metadata may be anonymized and associated with an anonymous unique identifier. For example, sensitive metadata (e.g., account number) may be removed from the account transaction metadata, and an anonymous unique identifier may comprise a one-way hash or a two-way encryption of the account number associated with the account transaction. The computing system may receive a set of digital content items (e.g., documents, files, videos, pictures, advertisements, and/or the like) selected based on the anonymized transaction metadata and/or anonymous unique identifier. The computing system may select a subset of the digital content items based on the anonymized account transaction metadata, anonymous unique identifier, and/or other metadata (e.g., metadata received with the set of digital content items and/or anonymized metadata for preceding transactions) to create the context-specific digital content (e.g., an HTML/XML document including banner image(s) and/or links associated with the ordered subset of digital content items).

In various embodiments, the computing system may use the anonymized account transaction metadata and/or supplemental metadata (e.g., URI of a retailer associated with the account transaction metadata) to provide context-specific digital content. For example, a retail purchase by a user at AutoZone may cause the computing system to provide an AutoZone advertisement (and/or an advertisement for a competitor and/or other related entity) on a client device of the user and/or a link to an associated website. Since the account transaction metadata and/or supplemental metadata (collectively, metadata) have been anonymized, and the association between a target (e.g., the user and/or user device) and the context-specific digital content is based on an anonymous unique identifier, the computing system may securely provide increased context for generating, selecting, and/or delivering context-specific digital content without compromising user privacy and/or security. For example, anonymized metadata may be passed between various systems (e.g., context-specific content delivery server system, client devices, content analytics systems, discussed further herein) and associated with digital content items selected based on the anonymized metadata with revealing an identity, account, and/or other private data of the user.

In some embodiments, the context-specific digital content may be presented within an application executing on a client device. For example, the application may comprise a mobile application (e.g., a video game or other mobile application). In some embodiments, the application may comprise a fraud detection application. For example, the fraud detection application may present a graphical user interface (GUI) displaying one or more recent account transactions (e.g., in real-time or at some time after the purchase) and context-specific digital content associated with those one or more recent account transactions (and/or other account transactions of that user). A user may identify whether one or more of the account transactions are valid or invalid, and one or more recipient systems (e.g., the computing system and/or financial institution associated with the account transaction) may be notified.

In some embodiments, the context-specific digital content may facilitate detection and/or determination of fraud. For example, the context-specific digital content may include a logo of the merchant for the displayed account transaction, a merchant category (e.g., auto parts retailer), a picture of the retail location of the merchant for the displayed account transaction, and/or other metadata for facilitating identification and/or recollection of the displayed account transaction.

Various embodiments of the present disclosure include systems, methods, and non-transitory computer readable media configured to receive a data chunk including account transaction metadata. The account transaction metadata of the data chunk is anonymized. Supplemental metadata is obtained, the supplemental metadata being obtained based on the anonymized account transaction metadata; annotating the data chunk using the supplemental metadata. The annotated data chunk is filtered, the filtering removing information capable of identifying an account of the account transaction metadata. The filtered annotated data chunk is provided for analysis by a remote third-party system. A set of digital content items provided by the remote third-party system is received, the set of digital content items provided based on analysis of the filtered annotated data chunk. Context-specific digital content is assembled based on the received digital content. The context-specific digital content is provided for presentation by a remote client device. In some embodiments, an operator (e.g., user) of a remote client device may select digital content that is deemed relevant. The selection may be reported back to one or more originating systems (e.g., financial institution system, financial management system, context-specific content delivery server system, content analytics system, and/or the like).

In some embodiments, the account transaction metadata comprises any of a billing descriptor, transaction amount, transaction date and/or time, transaction identifier, and an account identifier.

In some embodiments, the supplemental metadata comprises merchant information associated with a merchant associated with the account transactions. In related embodiments, the merchant information comprises any of a full name of the merchant, an address of the merchant, a telephone number of the merchant, a web site of the merchant, an e-mail address of the merchant, a logo of the merchant, a merchant category code (MCC), a geolocation of the merchant, and a map indicating the geolocation of the merchant.

In some embodiments, the anonymizing further causes the system to perform: creating, by the cloud-based system, a unique token based on a first portion of the account transaction metadata; storing, by the cloud-based system, the unique token in the data chunk; creating, by the cloud-based system, a mapping between the token and a second portion of the account transaction metadata, the second portion of the account transaction metadata being different from the first portion of the account transaction metadata; storing, by the cloud-based system, the mapping stored in an anonymized datastore; and removing, by the cloud-based system, a third portion of the account transaction metadata from the data chunk, the third portion of the account transaction including the first portion of the account transaction metadata.

In some embodiments, the assembling further causes the system to perform: selecting, by the cloud-based system, a subset of the of the digital content items based on information of the filtered annotated data chunk; and determining, by the cloud-based system, an order of the subset of the digital content items, the ordered subset of digital content items comprising the context-specific digital content.

In some embodiments, the data chunk includes a second set of digital content items associated with an entity providing the account transaction metadata.

In some embodiments, the supplemental metadata is obtained from a local datastore populated based on scraping one or more remote systems.

In some embodiments, the systems, methods, and non-transitory computer readable media are further configured to perform determining, by the cloud-based system prior to the annotating, whether supplemental metadata of the local datastore is stale; if the supplemental metadata of the local datastore is stale, obtain new supplemental metadata and replace the stale supplemental metadata with the new supplemental metadata.

In some embodiments, the systems, methods, and non-transitory computer readable media are further configured to perform creating, by the cloud-based system prior to the annotating, a set of keyword queries from information of the filtered annotated data chunk; executing, by the cloud-based system prior to the annotating, the set of keyword queries using a headless browser; replacing, by the cloud-based system prior to the annotating, at least a portion of the stale supplemental metadata with at least a portion of a result of executing the set of queries using the headless browser, the at least a portion of the result of executing the set of queries using the headless browser comprising the new supplemental metadata.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 depicts a diagram of an example environment for providing context-specific digital content based on account transaction metadata according to some embodiments.

FIG. 2 depicts a diagram of an example of a context-specific content delivery server system according to some embodiments.

FIG. 3 depicts a diagram of an example of a contextualizer subsystem according to some embodiments.

FIG. 4 depicts a diagram of an example of a client device according to some embodiments.

FIG. 5 depicts a flowchart of an example of a method of providing context-specific digital content based on account transaction metadata according to some embodiments.

FIG. 6 depicts a flowchart of an example of a method of operation of an example contextualizer subsystem according to some embodiments.

FIG. 7 depicts a flowchart of an example of a method of providing context-specific digital content based on account transaction metadata according to some embodiments.

FIG. 8 depicts a flowchart of an example of a method of fraud detection using account transaction metadata and supplemental metadata according to some embodiments.

FIG. 9 depicts a diagram of an example of a fraud detection graphical user interface (GUI) according to some embodiments.

FIG. 10 is a diagram of an example computer system for implementing the features disclosed herein.

### DETAILED DESCRIPTION

Embodiments of the current system provide context-specific digital content using anonymized metadata (e.g., account transaction metadata, personal metadata). For example, a computing system may receive account transaction metadata (e.g., transaction identifier, billing descriptor, account number) for one or more account transactions (e.g., a retail purchase at a particular retailer). Account transaction metadata may be received in real-time (e.g., at substantially the same time as the account transaction occurs) and/or in batches. The account transaction metadata may be anonymized and associated with an anonymous unique identifier. For example, sensitive metadata (e.g., account number) may be removed from the account transaction metadata, and the unique identifier may comprise a one-way hash or a two-way encryption of the account number associated with the account transaction. The computing system may receive a set of digital content items (e.g., documents, files, videos, pictures, advertisements, and/or the like) selected based on the anonymized transaction metadata and/or anonymous unique identifier. The computing system may select a subset of the digital content items based on the anonymized account transaction metadata, anonymous unique identifier, and/or other metadata (e.g., metadata received with the set of digital content items) to create the context-specific digital content (e.g., an HTML/XML document including banner image(s) and/or links associated with the ordered subset of digital content items).

In various embodiments, the computing system may use the anonymized account transaction metadata and/or supplemental metadata (e.g., URI of a retailer associated with the account transaction metadata) to provide context-specific digital content. For example, a retail purchase by a user at AutoZone may cause the computing system to provide an AutoZone advertisement (and/or an advertisement for a competitor and/or other related entity) on a client device of the user and/or a link to an associated website. Since the account transaction metadata and/or supplemental metadata (collectively, metadata) have been anonymized, and the association between a target (e.g., the user and/or user device) and the context-specific digital content is based on an anonymous unique identifier, the computing system may securely provide increased context for generating, selecting, and/or delivering context-specific digital content without compromising user privacy and/or security. For example, anonymized metadata may be passed between various systems (e.g., context-specific content delivery server system, client devices, content analytics systems, discussed further herein) and associated with digital content items selected based on the anonymized metadata without revealing an identity, account, and/or other private data of the user.

In some embodiments, the context-specific digital content may be presented within an application executing on a client device. For example, the application may comprise a mobile application (e.g., a video game or other mobile application). In some embodiments, the application may comprise a fraud detection application. For example, the fraud detection application may present a graphical user interface (GUI) displaying one or more recent account transactions (e.g., in real-time or at some time after the purchase) and context-specific digital content associated with those one or more recent account transactions (and/or other account transactions of that user). A user may identify whether one or more of the account transactions are valid or invalid, and one or more recipient systems (e.g., the computing system and/or financial institution associated with the account transaction) may be notified.

In some embodiments, the context-specific digital content may facilitate detection and/or determination of fraud. For example, the context-specific digital content may include a logo of the merchant for the displayed account transaction, merchant category (e.g., auto parts retailer), a picture of the retail location of the merchant for the displayed account transaction, and/or other metadata for facilitating identification and/or recollection of the displayed account transaction.

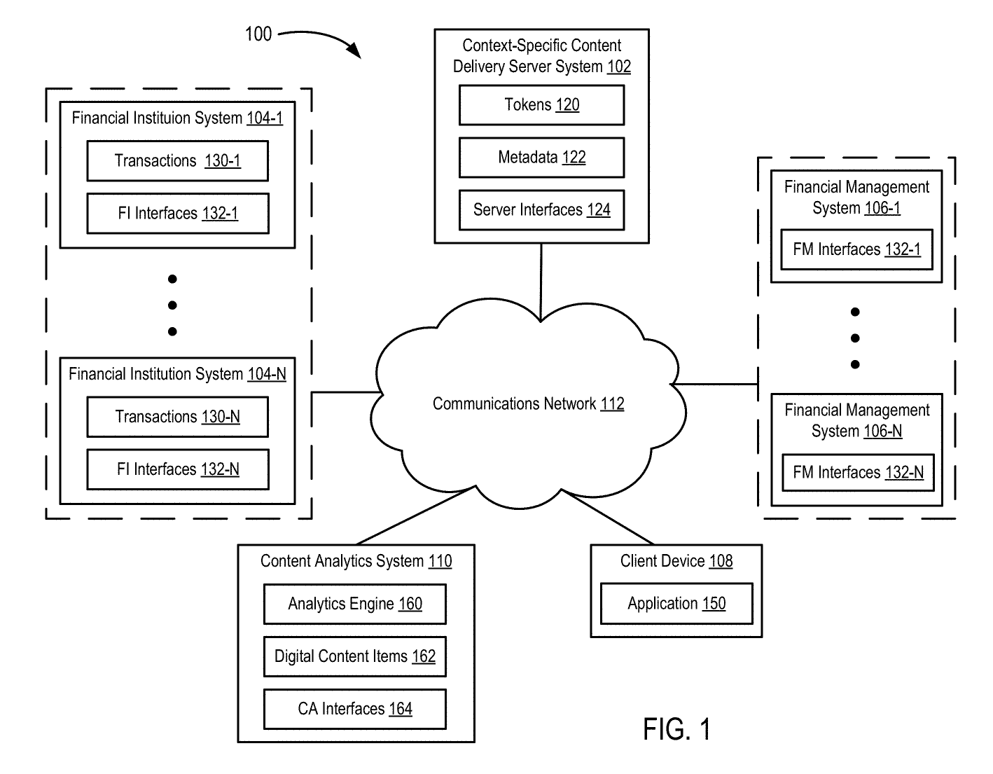

FIG. 1 depicts a diagram 100 of an example environment for providing context-specific digital content based on account transaction metadata according to some embodiments. In the example of FIG. 1, the environment includes a context-specific content delivery server system 102, financial institution systems 104-1 to 104-N (individually, the financial institution system 104, collectively, the financial institution systems 104), financial management systems 106-1 to 106-N (individually, the financial management system 106, collectively, the financial management systems 106), a client device 108, content analytics system 110, and a communication network 112.

The context-specific content delivery server system 102 may function to receive metadata 122 for one or more account transactions 130 (e.g., a retail purchase processed by financial institution system 104, discussed herein). The metadata 122 may include account transaction metadata (e.g., transaction identifier, billing descriptor, account number), supplemental metadata (e.g., full name of retailer, address of retailer, telephone number of retailer, email address of retailer, website address of retailer, and/or map/geolocation of retailer), and/or other data (e.g., digital content items). For example, the context-specific content delivery server system 102 may receive a transaction metadata stream from a remote system (e.g., a financial institution system 104 and/or financial management system 106, discussed herein) including metadata 122. In some embodiments, metadata 122 may be received in real-time (e.g., at substantially the same time as a corresponding account transaction 130 occurs) and/or in batches.

The context-specific content delivery server system 102 may function to provide context-specific digital content based on anonymized metadata 122. For example, the context-specific digital content may include an ordered subset of digital content items (e.g., a banner image and a link to an associated website) selected from a set of digital content items provided by a remote system. In various embodiments, functionality of the context-specific content delivery server system 102 may be performed by one or more servers (e.g., a cloud-based server) and/or other computing devices. The context-specific content delivery server system 102 may be implemented by dedicated server(s) or a cloud-computing platform. As used herein, a cloud-computing platform may refer to an on-demand cloud-computing platform, and/or other cloud-computing platform.

In some embodiments, the context-specific content delivery server system 102 anonymizes metadata 122 by constructing an anonymous unique identifier 120 (or, “token”) and removing any information from the metadata 122 that may be used by a third-party to determine the identity, account, and/or other private data of the user. The anonymized metadata 122 may be identified based on the token 120. This may allow, for the example, the context-specific content delivery server system 102 to securely provide increased context for generating, selecting, and/or delivering context-specific digital content without compromising user privacy and/or security. For example, using a token 120, the anonymized metadata 122 may be passed between various systems (e.g., context-specific content delivery server system 102, client devices 108, content analytics systems 110, discussed further herein) and associated with context-specific digital content without revealing an identity, account, and/or other private data of the user.

In some embodiments, the context-specific content delivery server system 102 functions to provide a data chunk including the anonymized metadata 122 and token 120 to one or more remote systems (e.g., the content analytics system 110). The context-specific content delivery server system 102 may assemble context-specific digital content from a set of digital content items (e.g., digital content items 162, discussed herein) selected based on the anonymized metadata 122 and/or token 120. For example, the context-specific content delivery server system 102 may select and/or order various portions of the set of digital content items, and/or combine the set of digital content items with other digital content items (e.g., digital content items provided by the financial institution system 104 associated with the account transaction).

In some embodiments, the context-specific content delivery server system 102 may provide the context-specific digital content to a remote system (e.g., client device 108) associated with a corresponding token 120. For example, the context-specific content delivery server system 102 may maintain a mapping between a user (and/or client device) 108 and the token 120. Based on the mapping, the context-specific content delivery server system 102 may provide the context-specific digital content to the appropriate user (and/or client device) 108.

In some embodiments, the context-specific content delivery server system 102 may cooperate with one or more remote systems using server interfaces 124. The server interfaces 124 may include application programming interfaces (APIs), software development kits (SDKs), source code, machine code, and/or server stubs. Accordingly, the server interfaces 124 may include files (e.g., source code files), documents, executables, and/or the like. The server interfaces 124 may, for example, include server API implementations.

The financial institution systems 104 may function to process account transactions 130 and provide account transaction metadata 122. For example, the financial institution systems 104 may include banks, credit issuers, and/or other institution where funds (e.g., physical, virtual) may be deposited, held, withdrawn, and/or transferred. In some embodiments, the financial institution systems 104 may function to provide digital content items. For example, financial institution systems 104 may provide digital content items related to in-house campaigns. In various embodiments, functionality of the financial institution systems 104 may be performed by one or more servers (e.g., a cloud-based server) and/or other computing devices.

In some embodiments, the financial institution systems 104 may cooperate with one or more remote systems (e.g., context-specific content delivery server system 102) using financial institution interfaces 132. The financial management interfaces 132 may include application programming interfaces (APIs), software development kits (SDKs), source code, machine code, and/or server stubs. Accordingly, the financial institution interfaces 132 may include files (e.g., source code files), documents, executables, and/or the like. The financial management interfaces 132 may, for example, include server API implementations.

The financial management systems 106 may function to provide account transaction metadata 122 associated with transactions processed by one or more associated financial institution systems 104. For example, the financial management systems 106 may include Mint.com and/or other aggregator and/or management systems. In some embodiments, functionality of the financial management systems 106 may be performed by one or more servers (e.g., cloud-based servers) and/or other computing devices.

In some embodiments, the financial management systems 106 may cooperate with one or more remote systems (e.g., context-specific content delivery server system 102) using financial management interfaces 140. The financial management interfaces 140 may include application programming interfaces (APIs), software development kits (SDKs), source code, machine code, and/or server stubs. Accordingly, the financial management interfaces 140 may include files (e.g., source code files), documents, executables, and/or the like. The financial management interfaces 140 may, for example, include server API implementations.

The client device 108 may function to present context-specific digital content. For example, the client device 108 may present content-specific digital content through an application 150 (e.g., a mobile app) executing on the client device 108. If a user selects (e.g., clicks) the presented context specific digital content, and/or portion thereof, the client device 108 may launch a temporary website (e.g., using a URI including a location of associated digital content, the unique identifier, and/or a tracking identifier) associated with the context-specific digital content. This may provide, for example, a mechanism for delivering and/or tracking of context-specific digital content in a stateless manner (e.g., without using cookies). In various embodiments, functionality of the client device 108 may be performed by one or more mobile devices, desktop computers, and/or other computing devices.

The content analytics system 110 may function to select and/or provide digital content items 162 to one or more remote systems (e.g., context-specific content delivery server system 102). For example, digital content items 162 may include media, pictures, video, files, documents, advertisements, and/or the like. In some embodiments, an analytics engine 160 may select and/or provide the digital content items 162 based on anonymized metadata 122 and/or tokens 120. In various embodiments, functionality of the content analytics system 110 may be performed by one or more servers (e.g., a cloud-based server) and/or other computing devices.

In some embodiments, the content analytics system 110 may cooperate with one or more remote systems (e.g., context-specific content delivery server system 102) using content analytics interfaces 164. The content analytics interfaces 164 may include application programming interfaces (APIs), software development kits (SDKs), source code, machine code, and/or server stubs. Accordingly, the content analytics interfaces 164 may include files (e.g., source code files), documents, executables, and/or the like. The content analytics interfaces 164 may, for example, include server API implementations.

The communication network 112 may represent one or more computer networks (e.g., LAN, WAN, or the like) or other transmission mediums. The communication network 112 may provide communication between systems 102-110 and/or other systems, subsystems, engines, and/or datastores described herein. In some embodiments, the communication network 112 includes one or more computing devices, routers, cables, buses, datastores, and/or network topologies (e.g., mesh, and/or the like). In some embodiments, the communication network 112 may be wired and/or wireless. In various embodiments, the communication network 112 may include the Internet, one or more networks that may be public, private, IP-based, non-IP based, and/or the like.

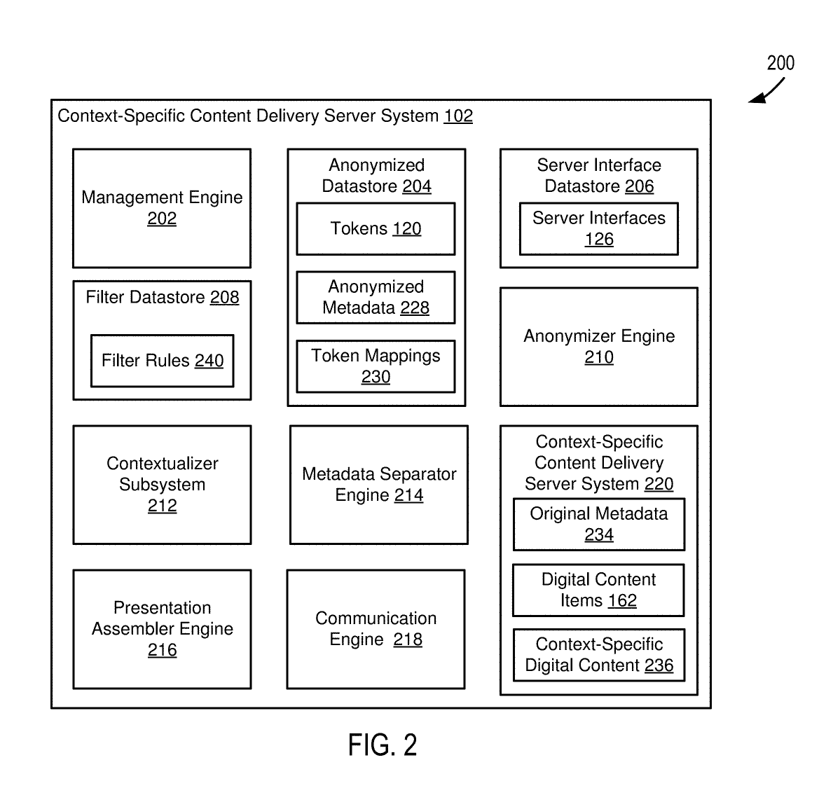

FIG. 2 depicts a diagram 200 of an example of a context-specific content delivery server system 102 according to some embodiments. In the example of FIG. 2, the context-specific content delivery server system 102 includes a management engine 202, an anonymized datastore 204, a server interface datastore 206, a filter datastore 208, an anonymizer engine 210, a contextualizer subsystem 212, a metadata separator engine 214, a presentation assembler engine 216, a communication engine 218, and a context-specific digital content delivery system datastore 220.

The management engine 202 may function to manage (e.g., create, read, update, delete, or otherwise access) tokens 120, anonymized metadata 228, and/or token mappings 230 stored in the anonymized datastore 204, server interfaces 126 stored in the server interface datastore 206, filter rules 240 stored in the filter datastore 208, and/or other data stored in other datastores (e.g., original/non-anonymized metadata 234, digital content items 162, context-specific digital content 236). The management engine 202 may perform any of these operations manually (e.g., by a user interacting with a GUI) and/or automatically (e.g., triggered by one or more of the engines/subsystems 210-218, discussed herein). In some embodiments, the management engine 202 includes a library of executable instructions, which are executable by one or more processors for performing any of the aforementioned management operations. Like other engines/subsystems described herein, functionality of the management engine 202 may be included in one or more other engines/subsystems (e.g., engines/subsystems 210-218).

The anonymized metadata 228 may include anonymized account transaction metadata and/or anonymized supplemental metadata. For example, anonymized metadata 228 may have been scrubbed to remove potentially identifying information (e.g., account numbers), as discussed elsewhere herein.

The token mappings 230 may facilitate anonymized associations of user accounts, account transactions, context-specific digital content, metadata, and/or digital content items. In some embodiments, the token mappings 230 may include a mapping between particular tokens 120 and the original transaction identifier of an account transaction. This may allow, for example, reconstruction of original metadata 234 from anonymized metadata 228.

The anonymizer engine 210 may function to create tokens 120 and anonymize original metadata 234 to create anonymized metadata 228. In some embodiments, the anonymizer engine 210 may generate a token 120 based on the account number of the original metadata 234 (e.g., a one-way hash or a two-way encryption of the account number). The anonymizer engine 210 may generate a mapping 230 between the token 120 and anonymized metadata 228, original metadata 234 (e.g., using the transaction identifier of the account transaction metadata), user accounts, and/or client devices 108. Once the token has been created, the anonymizer engine 210 may remove the account number, and/or other sensitive information from the metadata, and insert the token into the anonymized metadata 228 and/or associated structure (e.g., data chunk).

The contextualizer subsystem 210 may function to obtain supplemental metadata. In some embodiments, the contextualizer subsystem 210 may retrieve supplemental metadata from the web and/or other systems based on the anonymized metadata 228. For example, the contextualizer subsystem 210 may receive supplemental metadata provided by merchant systems, and/or the contextualizer subsystem 210 may scrape the web and/or other systems. In some embodiments, the contextualizer subsystem 210 may obtain merchant information associated with a merchant associated with an account transaction. For example, the merchant information may include a full name of the merchant, an address of the merchant, a telephone number of the merchant, a website of the merchant, an e-mail address of the merchant, a logo of the merchant, a merchant category code (MCC), a geolocation of the merchant, and/or a map indicating the geolocation of the merchant.

The metadata separator engine 214 may function to separate sensitive metadata from original metadata 234, anonymized metadata 228, and/or supplemental metadata based on filter rules 240. For example, the metadata separator engine 214 may remove the transaction identifier prior to the anonymized metadata 228 being transmitted to a remote system (e.g., content analytics system 110).

The presentation assembler engine 216 may function to combine metadata received from the metadata separator engine 214 with digital content items received from a remote system (e.g., content analytics system 110, financial institution system 104, financial management system 106) in order to select and/or order the digital content items to create context-specific digital content for presentation to a remote system (e.g., client device 108). The presentation assembler engine 216 may construct context-specific content including HTML and/or XML document(s) containing all the necessary data and functionality for presenting the context-specific digital content on a remote system.

The communication engine 218 may function to send requests, transmit and, receive communications, and/or otherwise provide communication with one or a plurality of systems, subsystems, and/or engines. In some embodiments, the communication engine 218 functions to encrypt and decrypt communications. The communication engine 218 may function to send requests to and receive data from one or more systems (e.g., the context-specific content delivery server system 102, the financial institution system 104, the financial management systems 106, the client device 108, and/or the content analytics system 110) through a network or a portion of a network (e.g., communication network 112). Depending upon implementation-specific considerations, the communication engine 218 may send requests and receive data through a connection, all or a portion of which may be a wireless connection. The communication engine 218 may request and receive messages, and/or other communications from associated systems.

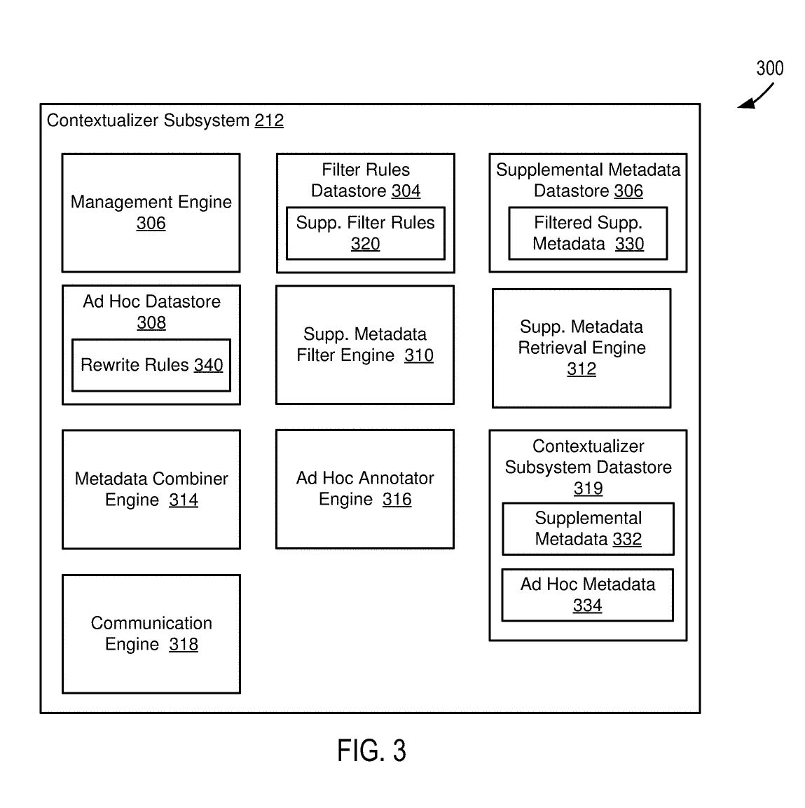

FIG. 3 depicts a diagram 300 of an example of a contextualizer subsystem 212 according to some embodiments. In the example of FIG. 3, the contextualizer subsystem 212 includes a management engine 302, a filter rules datastore 304, a supplemental metadata datastore 306, an ad hoc datastore 308, a supplemental metadata filter engine 310, a supplemental metadata retrieval engine 312, a metadata combiner engine 314, an ad hoc annotator engine 316, and a communication engine 318.

The management engine 302 may function to manage (e.g., create, read, update, delete, or otherwise access) supplemental filter rules 320 stored in the filter rules datastore 304, filtered supplemental metadata 330 stored in the supplemental metadata datastore 306, metadata rewrite rules 340 stored in the ad hoc datastore 308, and/or original supplemental metadata 332 and/or ad hoc metadata 334 stored in the contextualizer subsystem datastore 319. The management engine 302 may perform any of these operations manually (e.g., by a user interacting with a GUI) and/or automatically (e.g., triggered by one or more of the engines 310-318, discussed herein). In some embodiments, the management engine 302 includes a library of executable instructions, which are executable by one or more processors for performing any of the aforementioned management operations.

The supplemental metadata filter engine 310 may function to execute filter rules 320 to generate filtered supplemental metadata 330. The supplemental metadata filter engine 310 may strip particular supplemental metadata from original supplemental metadata 332. The filtered supplemental metadata 330 may be joined with existing filtered supplemental metadata 330.

The supplemental metadata retrieval engine 312 may function to retrieve original supplemental metadata 332. For example, the supplemental metadata retrieval engine 312 may retrieve the metadata 332 by scraping the web and/or other systems, manual user input, and/or the like. In some embodiments, supplemental metadata may be retrieved periodically and/or if supplemental metadata is stale. In some embodiments, existing supplemental metadata 332 may be used to construct a small set of web keyword queries. The queries may be executed (e.g., using a specialized “headless” web browser) resulting in structured data (e.g., web pages) being returned from the web. The supplemental metadata retrieval engine 312 may parse supplemental metadata and merged some or all of the parsed metadata into an existing transaction metadata chunk and/or stored supplemental metadata.

The metadata combiner engine 314 may function to annotate metadata, and/or a data chunk including account transaction metadata, using supplemental metadata. As used herein, it will be appreciated that reference to “metadata” may include account transaction metadata, original metadata, anonymized metadata, supplemental metadata, and/or filtered supplemental metadata. In some embodiments, the metadata combiner engine 314 may join a set of supplemental metadata with associated account transaction metadata (e.g., based on a corresponding billing descriptor). In another example, the metadata combiner engine 314 may join existing supplemental metadata with new or recently obtained supplemental metadata.

The ad hoc annotator engine 316 may function to annotate metadata, and/or a data chunk including the metadata, using ad hoc metadata rewrite rules 340. The ad hoc annotator engine 316 may perform “last-ditch” rewrites of metadata (e.g., including the creation and deletion of key/value pairs) before it is written back to the supplemental metadata datastore 306. For example, the ad hoc annotator engine 316 may insert ad hoc metadata 334 that could not otherwise be obtained by the supplemental metadata retrieval engine 312, such as merchant logos or merchant categories, which may not be accessible by some or all of the systems/engines described herein and/or may not be found via web-scraping. Ad hoc annotations 334 may be stored separately and/or as part of the filtered supplemental metadata 330.

The communication engine 318 may function to send requests, transmit and, receive communications, and/or otherwise provide communication with one or a plurality of systems, subsystems, and/or engines. In some embodiments, the communication engine 318 functions to encrypt and decrypt communications. The communication engine 318 may function to send requests to and receive data from one or more systems (e.g., the context-specific content delivery server system 102, the financial institution system 104, the financial management systems 106, the client device 108, and/or the content analytics system 110) through a network or a portion of a network (e.g., communication network 112). Depending upon implementation-specific considerations, the communication engine 318 may send requests and receive data through a connection, all or a portion of which may be a wireless connection. The communication engine 318 may request and receive messages, and/or other communications from associated systems.

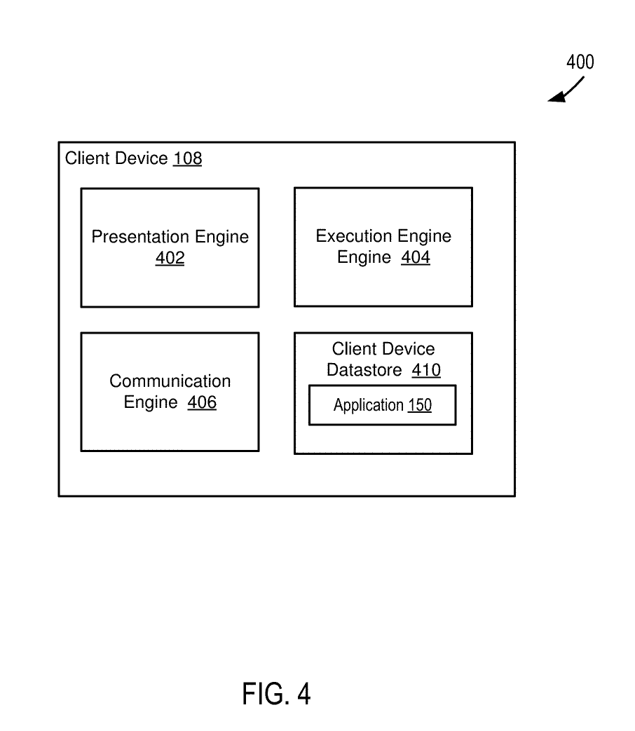

FIG. 4 depicts a diagram 400 of an example of a client device 108 according to some embodiments. In the example of FIG. 4, the client device 108 includes a presentation engine 402, an execution engine 404, a communication 406, and a client device datastore 408.

The presentation engine 402 may function to display and/or otherwise present content (e.g., context-specific digital content). For example, the presentation engine 402 may cooperate with, and/or include, one or more display devices, audio devices, and/or the like, to present the information.

The execution engine 404 may function to execute applications. For example, the execution engine 404 may execute application 150. For example, the application 150 may be stored in datastore 408. In some embodiments, the application 150 may comprise a local application, network application, stream-enabled application, and/or virtualized application.

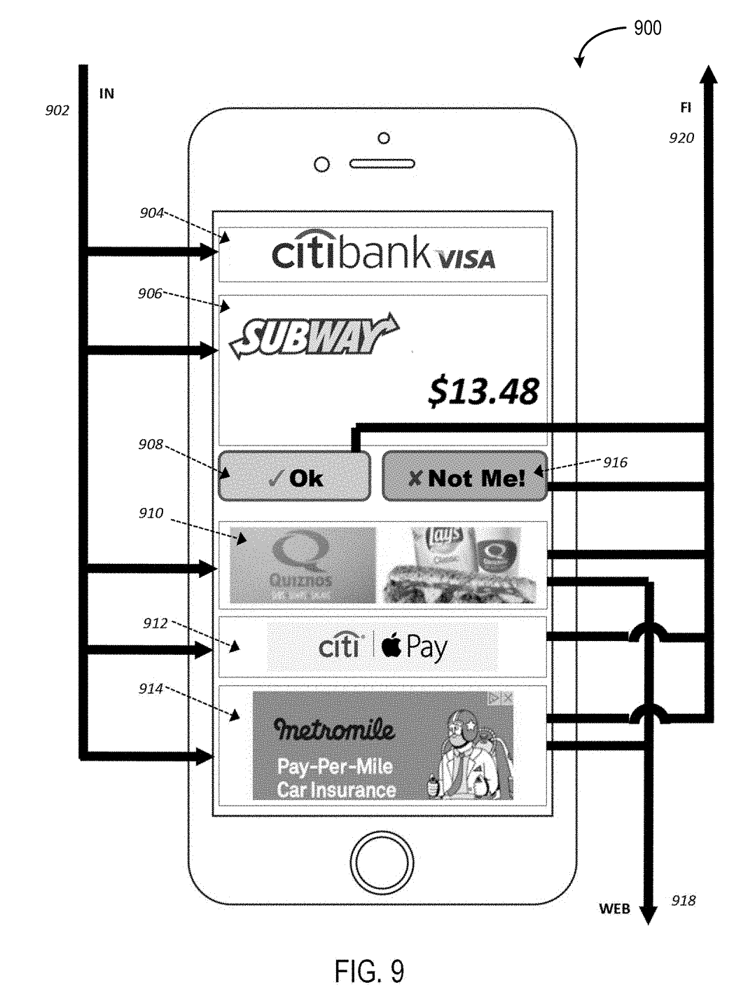

In some embodiments, the execution engine 404 executes a fraud detection application 150. For example, the fraud detection application 150 may present a graphical user interface (GUI) displaying one or more recent account transactions (e.g., in real-time or at some time after the purchase) and context-specific digital content associated with that account transaction and/or other account transactions associated with the same user account. In some embodiments, a user may identify whether one or more of the account transactions are valid or invalid, and one or more recipient systems (e.g., the context-specific content delivery server system 102 and/or financial institution system 104 associated with the account transaction) may be notified. An example fraud detection application 150 GUI is shown and discussed herein (e.g., with reference to FIG. 9).

In some embodiments, the application 150 may comprise an accounting application, and/or other type of authorization application, performing functionality instead of, or in addition to, fraud detection. For example, the application 150 may present account transactions of associated others users (e.g., family members), and selected users (e.g., parents) may be able identify authorized or unauthorized account transactions of other users (e.g., children).

The communication engine 406 may function to send requests, transmit and, receive communications, and/or otherwise provide communication with one or a plurality of systems, subsystems, and/or engines. In some embodiments, the communication engine 406 functions to encrypt and decrypt communications. The communication engine 406 may function to send requests to and receive data from one or more systems (e.g., the context-specific content delivery server system 102, the financial institution system 104, the financial management systems 106, the client device 108, and/or the content analytics system 110) through a network or a portion of a network (e.g., communication network 112). Depending upon implementation-specific considerations, the communication engine 406 may send requests and receive data through a connection, all or a portion of which may be a wireless connection. The communication engine 406 may request and receive messages, and/or other communications from associated systems. Communications may be stored temporarily and/or persistently in the client device datastore 408.

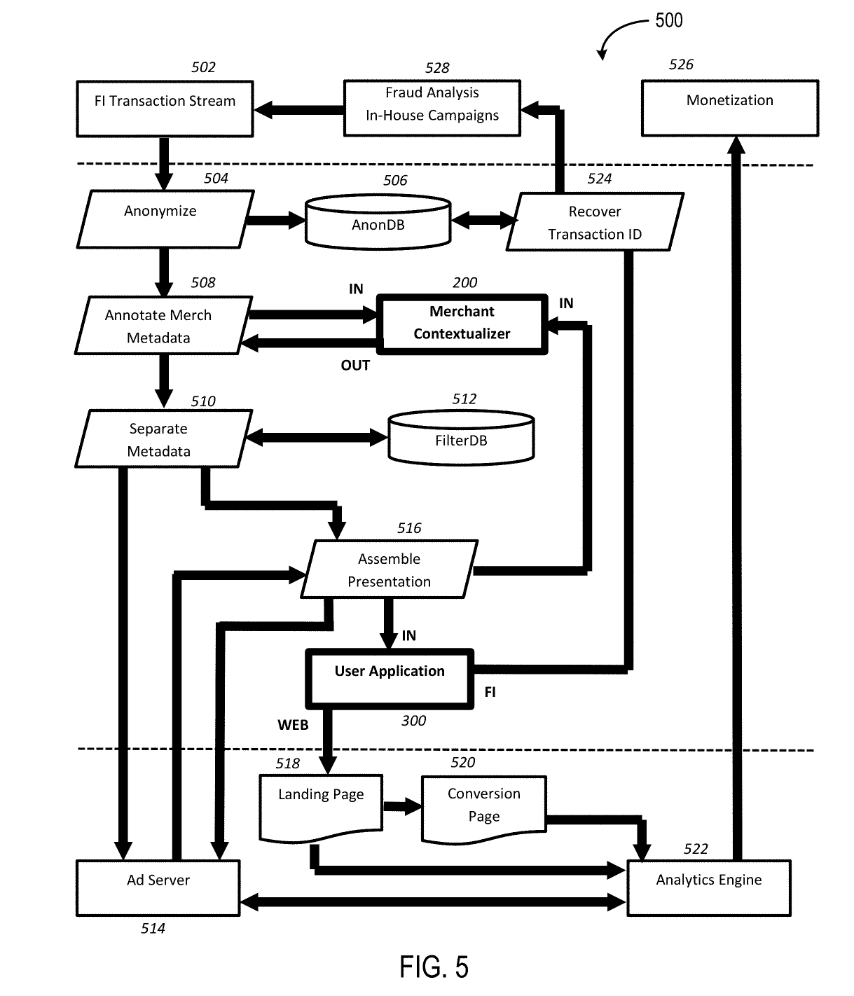

FIG. 5 depicts a flowchart 500 of an example of a method of providing context-specific digital content based on account transaction metadata according to some embodiments. In this and other flowcharts, the flowchart illustrates by way of example a sequence of steps. It should be understood the steps may be reorganized for parallel execution, or reordered, as applicable. Moreover, some steps that could have been included may have been removed for the sake of clarity and some steps that were included could be removed, but may have been included for the sake of clarity.

In step 502, a financial institution system (e.g., financial institution system 104) identifies an account transaction, packages account transaction metadata (e.g., account transaction metadata 234) in a data chunk, and provides the data chunk to a remote system (e.g., a context-specific content delivery server system (e.g., context-specific content delivery server system 102). In some embodiments, a financial institution interface (e.g., financial institution interface 132) cooperates with an interface (e.g., server interface 126) of the remote system to provide the data chunk over a communication network (e.g., communication network 112). Although a single account transaction is discussed in this example flowchart 502, it will appreciated multiple account transactions may also be used. For example, multiple account transactions and associated account transaction metadata may be packaged into one or more data chunks.

In some embodiments, whenever a transaction occurs, the financial institution system packages the relevant metadata into a data chunk and transmits it to an anonymizer engine (e.g., anonymizer engine 210). The metadata may at least include a billing descriptor, amount, transaction ID and an account number. Other types of data may include (but are not limited to): date and time of the transaction; posted date; account balance; credit limit; remaining credit; award points earned; award point balance; original currency used and amount in original currency; FI logo banner; account type logo banner; FI/account URI; merchant category code (MCC). In some embodiments, the data may include actual advertisements, provided by the financial institution itself (e.g., as part of an in-house ad campaign).

In step 504, the context-specific content delivery server system receives the data chunk and anonymizes the data chunk. In some embodiments, the anonymizer engine receives and/or anonymizes the data chunk. In some embodiments, the anonymizer engine uses the account number in the chunk to construct a one-way hash (or two-way encryption) which is then stored as a new key/value pair token in the chunk. A mapping between the hash value and the original transaction ID may be stored in a separate database (e.g., anonymized datastore 204). See step 506. In some embodiments, the anonymizer engine may next remove any and all metadata (e.g., including the account number) that may allow the user, account and/or financial institution to be identified by a third party.

In step 508, a contextualizer subsystem (e.g., contextualizer subsystem 212) may use the data chunk (e.g., including the billing descriptor) in order to obtain additional (or, “supplemental”) metadata, such as full name of merchant, address, telephone number, website, e-mail address, merchant logo, merchant category code (MCC), merchant geolocation and map. This new supplemental metadata may be added to the input chunk.

In steps 510-512, the context-specific content delivery server system determines, via consulting rules (e.g., filter rules 240, 320 and/or 340), which metadata is too sensitive to be sent to a content analytics system (e.g., content analytics system 110). The original, unmodified chunk, which in some embodiments, must include the token, may be transmitted directly to a presentation assembler engine (e.g., presentation assembler engine 216). See step 516. Then, all sensitive metadata (e.g., including the transaction ID) may be removed and the resulting chunk may be sent to the content analytics system.

In step 514, more specifically, the content analytics system receives the metadata for the current transaction, sends the metadata a back-end (e.g., analytics engine 160), receives the set digital content items (e.g., digital content items 162) which should be displayed, and then transmits the digital content items to the presentation assembler engine. Each digital content item may include, for example, a banner image suitable for display on a mobile device screen and (ii) a URI to be opened in a web browser when the user clicks/taps on the digital content item. In addition to digital content items, the content analytics system may also return additional metadata pertaining to the transaction, (e.g., merchant categories, merchant maps, merchant logos).

In step 516, the presentation assembler combines the preserved metadata received from the metadata separator engine with the received digital content items (and possibly additional metadata) in order to create the content-specific digital content. In some embodiments, the presentation assembler engine may notify the content analytics systems as to which of its digital content items it has decided to display, and in what positions. In some embodiments, the presentation assembler engine constructs an HTML or XML document containing all the necessary data and functionality, and sends it to the user application (e.g., application 150) for display. In some embodiments, if the content analytics systems returned merchant metadata in addition to digital content items, the presentation assembler engine may forward the merchant metadata to the contextualizer subsystem.

In steps 518-526, if the user clicks on one of the digital content items provided by the user will be directed to a “landing page” (step 518) URL provided for each of the digital content items. The URL may contain a parameter used to track the user by the analytics engine (step 522), including whether or not the user reaches a “conversion page” (step 520), which may indicate the completion of a purchase. Based on ad impressions (i.e., which ads the user sees in-app), user click-through (step 518) and possible acquisition (step 520), the financial institution system may receive a portion of the revenue (step 526) generated by a network of digital content item providers.

In some embodiments, data chunks sent from the application to financial institution systems may be required to have their transaction identifier recovered (step 524) using the taken mapping 230 constructed by the anonymizer engine.

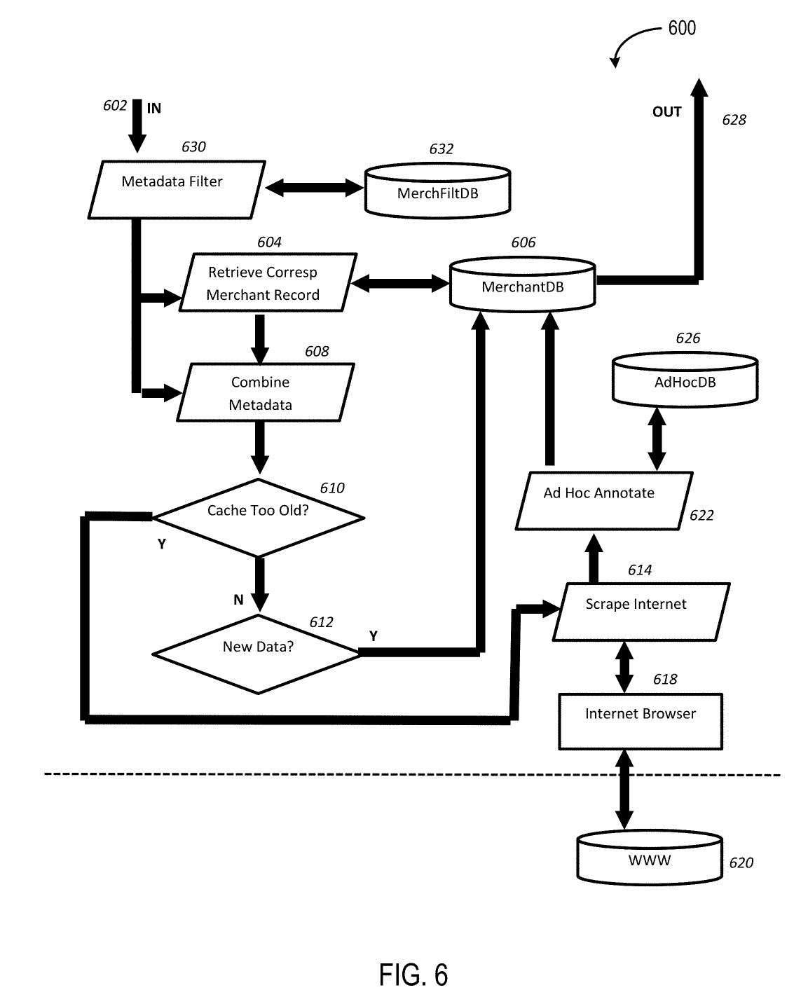

FIG. 6 depicts a flowchart 600 of an example of a method of operation of an example contextualizer subsystem (e.g., contextualizer subsystem 212) according to some embodiments.

In step 602, when a new data chunk arrives, it is first stripped of any metadata that does not belong (e.g., according to filter rules 240 and/or supplemental filter rules 320). In some embodiments, the contextualizer subsystem maintains a persistent database, indexed by billing descriptor and containing all discovered metadata attributes for a given merchant. This mechanism may be used for data that is volatile (e.g., changing) between transactions involving the same merchant (e.g., advertisements). Once the metadata is filtered/sanitized, its billing descriptor may be used to retrieve merchant information for the merchant (step 604) that is already stored (step 606), and the two metadata sets are merged (step 608).

In some embodiments, the contextualizer subsystem may then determine whether the cached database (e.g., supplemental metadata datastore 306) entry does not exist or has expired (steps 610-612), and needs to be refreshed. If it does, the merged metadata set obtained from step 608 is used to construct a small set of web keyword queries (step 614). These queries may then be executed using a specialized “headless” web browser (step 618) resulting in structured data (e.g., usually in the form of web pages) being returned from the larger web (step 620). This structured data may then parsed and additional merchant information such as full name, address, telephone, email, website and map/location is extracted and merged into the existing transaction metadata chunk, which in turn is transmitted to the ad hoc annotator engine (step 622).

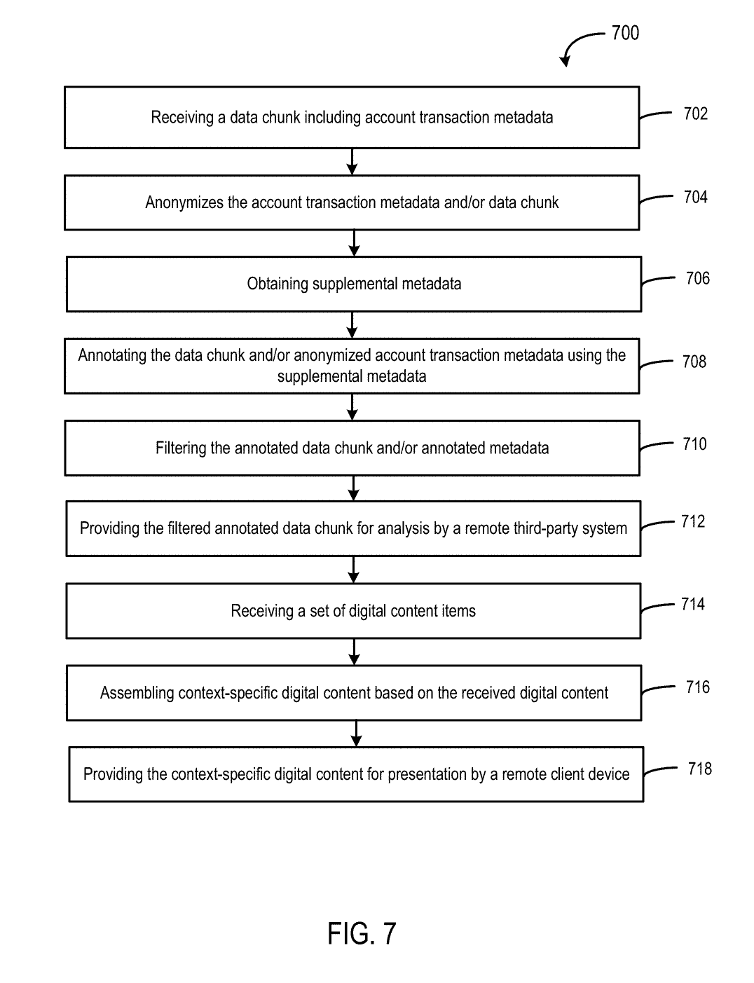

FIG. 7 depicts a flowchart 700 of an example of a method of providing context-specific digital content based on account transaction metadata according to some embodiments according to some embodiments.

In step 702, a cloud-based system (e.g., context-specific content delivery server system 102) receives a data chunk including account transaction metadata (e.g., account transaction metadata 234). For example, the account transaction metadata may include a billing descriptor, transaction amount, transaction identifier, and/or an account identifier. Although a data chunk is described in the example flowchart 700, it will be appreciated that some embodiments may use one or more other structures instead of, in addition to, a data chunk. In some embodiments, a communication engine (e.g., communication engine 218) and/or anonymizer engine (e.g., anonymizer engine 210) receives the data chunk over a communication network (e.g., communication network 112) from a remote system (e.g., a financial institution system 104, a financial management system 106).

In step 704, the cloud-based system anonymizes the account transaction metadata of the data chunk. In some embodiments, the anonymizer engine anonymizes the account transaction metadata. In some embodiments, anonymizing account transaction metadata may include creating a unique token based on a first portion of the account transaction metadata (e.g., account number), storing/inserting the unique token in the data chunk, creating a mapping between the unique token and a second portion (e.g., transaction identifier) of the account transaction metadata, and removing a third portion (e.g., the account number) of the account transaction metadata from the data chunk.

In step 706, the cloud-based system obtains supplemental metadata (e.g., supplemental metadata 332). The supplemental metadata may include merchant information associated with a merchant associated with the account transactions. For example, the merchant information may include a full name of the merchant, an address of the merchant, a telephone number of the merchant, a website of the merchant, an e-mail address of the merchant, a logo of the merchant, merchant category code (MCC), a geolocation of the merchant, and/or a map indicating the geolocation of the merchant. The supplemental metadata may be obtained based on the anonymized account transaction metadata. In some embodiments, a supplemental metadata engine (e.g., supplemental metadata retrieval engine 312) obtain the supplemental metadata and/or stores (e.g., temporarily) the supplemental metadata in a datastore (e.g., contextualizer subsystem datastore 319).

In step 708, the cloud-based system annotates the data chunk using the supplemental metadata. In some embodiments, a contextualizer subsystem (e.g., contextualizer subsystem 212) annotates the data chunk. For example, a metadata combiner engine (e.g., metadata combiner engine 314) annotates the data chunk.

In step 710, the cloud-based system filters the annotated data chunk. The filtering may remove information capable of identifying an account of the account transaction metadata from the data chunk and/or supplemental metadata. In some embodiments, a metadata filter engine (e.g., supplemental metadata filter engine 310) performs the filtering based on one or more metadata filter rules (e.g., metadata filter rules stored in the metadata filter rules datastore 320). In some embodiments, the management engine may store filtered supplemental metadata in a metadata datastore (e.g., supplemental metadata datastore 306).

In some embodiments, the metadata combiner engine merges the anonymized account transaction metadata and the supplemental metadata (e.g., into a single set of metadata) and then filters the supplemental metadata from the merged metadata. In some embodiments, the metadata filter engine filters the supplemental metadata and then merges the filtered supplemental metadata and the anonymized account transaction metadata.

In step 712, the cloud-based system provides the filtered annotated data chunk for analysis by a remote third-party system (e.g., content analytics system 110). In some embodiments, the communication engine provides the filtered annotated data chunk to the remote third-party system using a server system interface (e.g., server interface 124) cooperating with a content analytics system interface (e.g., content analytics interface 164).

In step 714, the cloud-based system receives a set of digital content items (e.g., digital content items 162) provided by the remote third-party system. The set of digital content items may be selected and/or provided based on analysis of the filtered annotated data chunk. In some embodiments, an analytics engine (e.g., analytics engine 160) selects and/or provides the set of digital content items.

In step 716, the cloud-based system assembles context-specific digital content (e.g., context-specific digital content 236) based on the received digital content. For example, the cloud-based system may assemble the context-specific digital content in response to a remote trigger (e.g., from application 150). In various embodiments, some or all of the steps 702-718 may be performed in response to one or more triggers (e.g., a user launching, and/or otherwise interacting with, the application 150 on the client device 108). In some embodiments, a presentation assembler engine (e.g., presentation assembler engine 216) assembles the context-specific digital content.

In step 718, the cloud-based system provides the context-specific digital content for presentation by a remote client device (e.g., client device 108). In some embodiments, the communication engine provides the context-specific digital content over the communication network to the remote client device for presentation through an application (e.g., application 150) executed by an execution engine (e.g., execution engine 404).

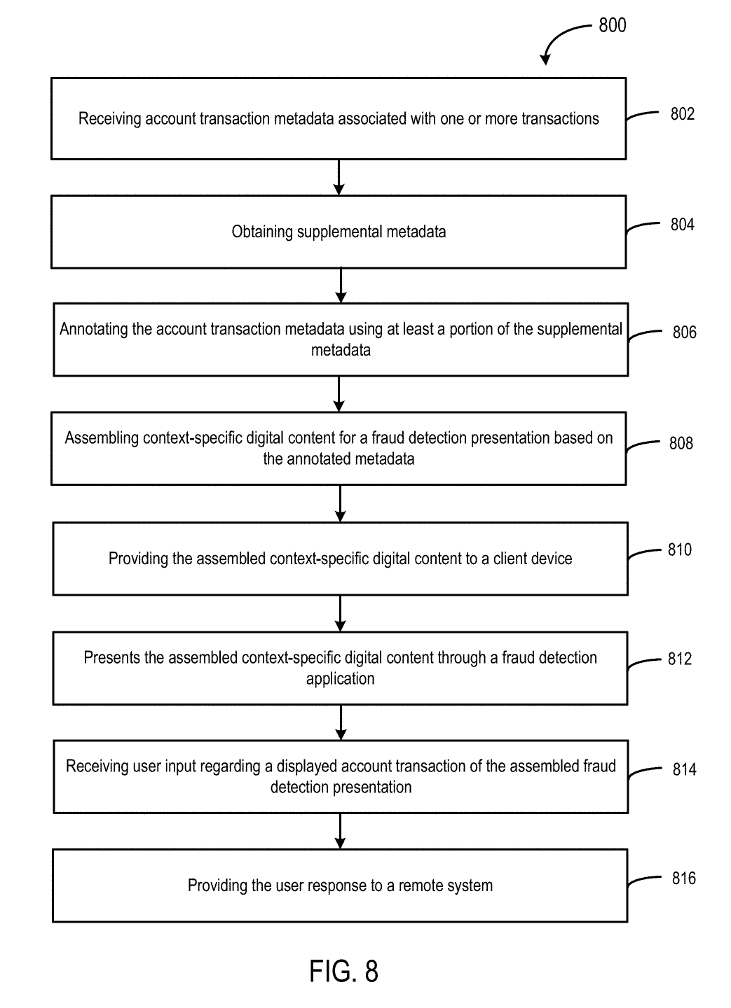

FIG. 8 depicts a flowchart 800 of an example of a method of fraud detection using account transaction metadata and supplemental metadata according to some embodiments.

In step 802, a cloud-based system (e.g., context-specific content delivery server system 102) receives account transaction metadata (e.g., account transaction metadata 234) associated with one or more transactions (e.g., account transactions 130). In some embodiments, a communication engine (e.g., communication engine 218) receives the account transaction metadata over a communication network (e.g., communication network 112).

In step 804, the cloud-based system obtains/retrieves supplemental metadata. In some embodiments, a supplemental metadata retrieval engine (e.g., supplemental metadata retrieval engine 312) retrieves the supplemental metadata.

In step 806, the cloud-based system annotates the account transaction metadata using at least a portion of the supplemental metadata. In some embodiments, a metadata combiner engine (e.g., metadata combiner engine 314) annotates the account transaction metadata.

In step 808, the cloud-based system assembles context-specific digital content for a fraud detection presentation based on the annotated metadata. In some embodiments, a presentation assembler engine 216 assembles the context-specific digital content for a fraud detection presentation.

In step 810, the cloud-based system provides the assembled context-specific digital content to a client device (e.g., client device 108). In some embodiments, the communication engine provides the assembled context-specific digital content to the client device over the communication network.

In step 812, the client device presents (e.g., displays) the assembled context-specific digital content through a fraud detection application (e.g., application 150). For example, the fraud detection application may present one or more account transactions, and the assembled context-specific digital content. The assembled context-specific digital content may be assembled such that it corresponds to (e.g., is adjacent to) the account transaction in order to provide a context for the user to determine whether the presented account transaction is valid or invalid. In some embodiments, an execution engine (e.g., execution engine 404) executes the fraud detection application, and a presentation engine (e.g., presentation engine 402) presents the assembled context-specific digital content.

In step 814, the client device receives user input regarding a displayed account transaction of the assembled fraud detection presentation. For example, a user may select invalid or valid. In some embodiments, the presentation engine may receive the user input.

In step 816, the client device provides the user response to a remote system (e.g., context-specific content delivery server system 102, financial institution system 104). In some embodiments, a selection of the context-specific digital content, or portion thereof, may result in a determination of a valid displayed transaction, which may be provided to the remote system.

FIG. 9 depicts a diagram 900 of an example of a contextualized advertising and fraud detection graphical user interface (GUI) according to some embodiments. The example GUI includes an input 902 including a first portion 904 of context-specific digital content, a second portion 906 of context-specific digital content, a valid transaction icon 908, an invalid transaction icon 916, a third portion 910 of context-specific digital content, a fourth portion 912 of context-specific digital content, and a fifth portion 914 of context-specific digital content. A user may select either the valid icon 908 or invalid icon 916, and the output 920 may be provided to the associated financial institution system (e.g., financial institution system 104). Selection of various portions 902-916 may launch content associated with the financial institution (e.g., as part of an in-house campaign) and/or other source (e.g., a website of a merchant).

In some embodiments, the GUI may allow the user to perform several actions. By clicking on the ‘Ok’ icon 908, the user may acknowledge that the transaction displayed is valid, and this information may be sent back to the financial institution system. By clicking on the ‘Not Me!’ icon 916, the user may be indicating that the displayed transaction is possibly fraudulent, and the financial institution system may be notified. By clicking on the account banner 904, the user may be directed to the financial institution system's website and/or to a personal finance manager (PFM) app (e.g., if one is installed on the client device). By clicking on the transaction box 906, the user may be presented with a pop-up dialog showing all available transaction details which were previously acquired (e.g., in steps 502, 508, 514, 514 and 622 of FIGS. 5 and 6, discussed herein).

In some embodiments, if the user clicks on one of portion 910, 914, the user may be directed to a “landing page” URI provided for each corresponding portion of the context-specific digital content. The URI may contain a parameter used to track the user by the content analytics system 110, including whether or not the user reaches a “conversion page” (e.g., typically indicating the completion of a purchase).

In some embodiments, if the user clicks on an in-house digital content item, there may not be any URI to display in a browser; instead, the click may be forwarded to the financial institution system to record as part of its in-house campaign.

In some embodiments, clicking on any of the digital content items of the context-specific digital content (e.g., whether in-house or obtained from the content analytics system) may imply that the user does not view the transaction as being possibly fraudulent (e.g., just as if the ‘Ok’ icon 908 was clicked). Furthermore, any data chunks sent from the application 150 to the financial institution system may first have their transaction ID recovered using the token mapping 230 constructed by the anonymizer engine 210.

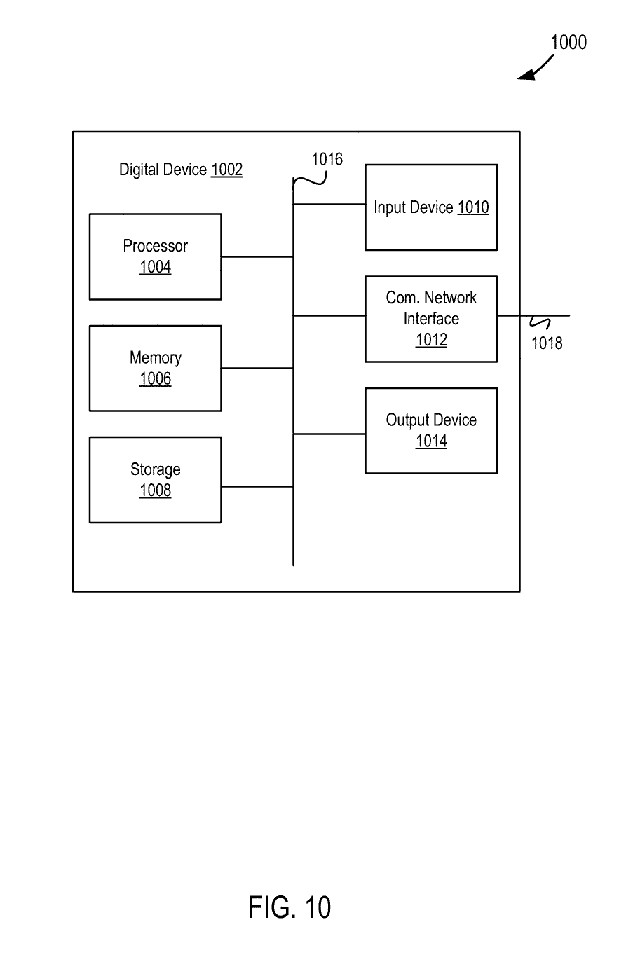

FIG. 10 depicts a diagram 1000 of an example of a computing device 1002. Any of the systems 102-110 and the communication network 112 may comprise an instance of one or more computing devices 1002. In some embodiments, the computing device 1002 comprises a processor 1004, memory 1006 and/or storage 1008, an input device 1010, a communication network interface 1012, and an output device 1014 communicatively coupled to a communication channel 1016. The processor 1004 is configured to execute executable instructions (e.g., programs). In some embodiments, the processor 1004 comprises circuitry or any processor capable of processing the executable instructions.

The memory 1006 stores data. Some examples of memory 1006 include storage devices, such as RAM, ROM, RAM cache, virtual memory, etc. In various embodiments, working data is stored within the memory 1006. The data within the memory 1006 may be cleared or ultimately transferred to the storage 1008.

The storage 1008 includes any storage configured to retrieve and store data. Some examples of the storage 1008 include flash drives, hard drives, optical drives, cloud storage, and/or magnetic tape. Each of the memory system 1006 and the storage system 1008 comprises a computer-readable medium, which stores instructions or programs executable by processor 1004.

The input device 1010 is any device that inputs data (e.g., mouse and keyboard). The output device 1014 outputs data (e.g., a speaker or display). It will be appreciated that the storage 1008, input device 1010, and output device 1014 may be optional. For example, the routers/switchers may comprise the processor 1004 and memory 1006 as well as a device to receive and output data (e.g., the communication network interface 1012 and/or the output device 1014).

The communication network interface 1012 may be coupled to a network (e.g., network 112) via the link 1018. The communication network interface 1012 may support communication over an Ethernet connection, a serial connection, a parallel connection, and/or an ATA connection. The communication network interface 1012 may also support wireless communication (e.g., 802.11a/b/g/n, WiMax, LTE, WiFi). It will be apparent that the communication network interface 1012 may support many wired and wireless standards.

It will be appreciated that the hardware elements of the computing device 1002 are not limited to those depicted in FIG. 10. A computing device 1002 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1004 and/or a co-processor located on a GPU (.e.g., Imagination Technologies, NVIDIA).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance.

The datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A computing system comprising:
one or more processors; and
memory storing instructions that, when executed by the one or more processors, cause the computing system to perform:
receiving, by a cloud-based system, a data chunk including account transaction metadata;
anonymizing, by the cloud-based system, the account transaction metadata of the data chunk;
obtaining, by the cloud-based system, supplemental metadata, the supplemental metadata being obtained based on the anonymized account transaction metadata;
annotating, by the cloud-based system, the data chunk using the supplemental metadata;
filtering, by the cloud-based system, the annotated data chunk, the filtering removing information capable of identifying an account or user associated with the account transaction metadata;
providing, by the cloud-based system, the filtered annotated data chunk for analysis by a remote third-party system;
receiving, by the cloud-based system, a first set of digital content items provided by the remote third-party system, the first set of digital content items provided based on analysis of the filtered annotated data chunk;
assembling, by the cloud-based system, context-specific digital content based on the first set of digital content items; and
providing, by the cloud-based system, the context-specific digital content for presentation by a remote client device.

2. The system of claim 1, wherein the account transaction metadata comprises any of a billing descriptor, a transaction amount, a transaction identifier, and an account identifier.

3. The system of claim 1, wherein the supplemental metadata comprises merchant information associated with a merchant associated with the account transaction metadata.

4. The system of claim 3, wherein the merchant information comprises any of a full name of the merchant, an address of the merchant, a telephone number of the merchant, a website of the merchant, an e-mail address of the merchant, a logo of the merchant, a merchant category code (MCC), a geolocation of the merchant, and a map indicating the geolocation of the merchant.

5. The system of claim 1, wherein the anonymizing further causes the system to perform:
creating, by the cloud-based system, a unique token based on a first portion of the account transaction metadata;
storing, by the cloud-based system, the unique token in the data chunk;
creating, by the cloud-based system, a mapping between the unique token and a second portion of the account transaction metadata, the second portion of the account transaction metadata being different from the first portion of the account transaction metadata;
storing, by the cloud-based system, the mapping in an anonymized datastore; and
removing, by the cloud-based system, a third portion of the account transaction metadata from the data chunk, the third portion of the account transaction metadata including the first portion of the account transaction metadata.

6. The system of claim 1, wherein the assembling further causes the system to perform:
selecting, by the cloud-based system, a subset of the first set of digital content items based on information of the filtered annotated data chunk; and
determining, by the cloud-based system, an order of the subset of the first set of digital content items, the ordered subset of the first set of digital content items comprising the context-specific digital content.

7. The system of claim 1, wherein the data chunk includes a second set of digital content items associated with an entity providing the account transaction metadata.

8. The system of claim 1, wherein the supplemental metadata is obtained from a local datastore populated based on scraping one or more remote systems.

9. The system of claim 8, wherein the instructions further cause the system to perform:
determining, by the cloud-based system prior to the annotating, whether the supplemental metadata of the local datastore is stale; and
if the supplemental metadata of the local datastore is stale:
obtaining new supplemental metadata; and
replacing the stale supplemental metadata with the new supplemental metadata.

10. The system of claim 9, wherein the instructions further cause the system to perform:
creating, by the cloud-based system prior to the annotating, a set of keyword queries from information of the filtered annotated data chunk;
executing, by the cloud-based system prior to the annotating, the set of keyword queries using a headless browser;
replacing, by the cloud-based system prior to the annotating, at least a portion of the stale supplemental metadata with at least a portion of a result of executing the set of queries using the headless browser, the at least a portion of the result of executing the set of queries using the headless browser comprising the new supplemental metadata.

11. A method being implemented by a computing system including one or more physical processors and storage media storing machine-readable instructions, the method comprising:
receiving, by a cloud-based system, a data chunk including account transaction metadata;
anonymizing, by the cloud-based system, the account transaction metadata of the data chunk;
obtaining, by the cloud-based system, supplemental metadata, the supplemental metadata being obtained based on the anonymized account transaction metadata;
annotating, by the cloud-based system, the data chunk using the supplemental metadata;
filtering, by the cloud-based system, the annotated data chunk, the filtering removing information capable of identifying an account or user associated with the account transaction metadata;
providing, by the cloud-based system, the filtered annotated data chunk for analysis by a remote third-party system;
receiving, by the cloud-based system, a first set of digital content items provided by the remote third-party system, the first set of digital content items provided based on analysis of the filtered annotated data chunk;
assembling, by the cloud-based system, context-specific digital content based on the first set of digital content items; and
providing, by the cloud-based system, the context-specific digital content for presentation by a remote client device.

12. The method of claim 11, wherein the account transaction metadata comprises any of a billing descriptor, a transaction amount, a transaction identifier, and an account identifier.

13. The method of claim 11, wherein the supplemental metadata comprises merchant information associated with a merchant associated with the account transaction data.

14. The method of claim 13, wherein the merchant information comprises any of a full name of the merchant, an address of the merchant, a telephone number of the merchant, a website of the merchant, an e-mail address of the merchant, a logo of the merchant, a merchant category code (MCC), a geolocation of the merchant, and a map indicating the geolocation of the merchant.

15. The method of claim 11, further comprising:
creating, by the cloud-based system, a unique token based on a first portion of the account transaction metadata;
storing, by the cloud-based system, the unique token in the data chunk;
creating, by the cloud-based system, a mapping between the unique token and a second portion of the account transaction metadata, the second portion of the account transaction metadata being different from the first portion of the account transaction metadata;
storing, by the cloud-based system, the mapping in an anonymized datastore; and
removing, by the cloud-based system, a third portion of the account transaction metadata from the data chunk, the third portion of the account transaction metadata including the first portion of the account transaction metadata.

16. The method of claim 11, further comprising:
selecting, by the cloud-based system, a subset of the first set of digital content items based on information of the filtered annotated data chunk; and
determining, by the cloud-based system, an order of the subset of the first set of digital content items, the ordered subset of the first set of digital content items comprising the context-specific digital content.

17. The method of claim 11, wherein the data chunk includes a second set of digital content items associated with an entity providing the account transaction metadata.

18. The method of claim 11, wherein the supplemental metadata is obtained from a local datastore populated based on scraping one or more remote systems.

19. The method of claim 18, further comprising:
determining, by the cloud-based system prior to the annotating, whether supplemental metadata of the local datastore is stale; and
if the supplemental metadata of the local datastore is stale:
obtaining new supplemental metadata; and
replacing the stale supplemental metadata with the new supplemental metadata.

20. The method of claim 19, further comprising:
creating, by the cloud-based system prior to the annotating, a set of keyword queries from information of the filtered annotated data chunk;
executing, by the cloud-based system prior to the annotating, the set of keyword queries using a headless browser;
replacing, by the cloud-based system prior to the annotating, at least a portion of the stale supplemental metadata with at least a portion of a result of executing the set of queries using the headless browser, the at least a portion of the result of executing the set of queries using the headless browser comprising the new supplemental metadata.

21. A non-transitory computer readable medium comprising instructions that, when executed, cause one or more processors to perform:
receiving a data chunk including account transaction metadata;
anonymizing the account transaction metadata of the data chunk;
obtaining supplemental metadata, the supplemental metadata being obtained based on the anonymized account transaction metadata;
annotating the data chunk using the supplemental metadata;
filtering the annotated data chunk, the filtering removing information capable of identifying an account associated with the account transaction metadata;
providing the filtered annotated data chunk for analysis by a remote third-party system;
receiving a set of digital content items provided by the remote third-party system, the set of digital content items provided based on analysis of the filtered annotated data chunk;
assembling context-specific digital content based on the set of digital content items; and
providing the context-specific digital content for presentation by a remote client device.
